(19) United States
(12) Patent Application Publication
(10) Pub. No.: US 2011/0321167 A1
(43) Pub. Date: Dec. 29, 2011

(54) AD PRIVACY MANAGEMENT

(75) Inventors: Ping Wu, San Bruno, CA (US); Anita Krishnakumar, San Mateo, CA (US); Deepak Chandra, Mountain View, CA (US)

(73) Assignee: GOOGLE INC., Mountain View, CA (US)

(21) Appl. No.: 12/821,771

(22) Filed: Jun. 23, 2010

(51) Int. Cl. G06F 21/24; G06Q 30/00

(52) U.S. Cl. 726/26; 705/14.4

(57) ABSTRACT

In general, this specification relates to content presentation. In general, one aspect of the subject matter described in this specification can be embodied in methods that include the actions of receiving a privacy request from a mobile device, the privacy request including an encoded device identifier; authenticating the request; decoding the device identifier; retrieving mobile device advertising data associated with the decoded device identifier; and applying the privacy request to the mobile device advertising data. Other embodiments of this aspect include corresponding systems, apparatus, and computer program products.

### BACKGROUND

The present disclosure relates to content presentation.

Advertisers provide advertisements in different forms in order to attract consumers. An advertisement (“ad”) is a piece of information designed to be used in whole or part by a user, for example, a particular consumer. Ads can be provided in electronic form. For example, online ads can be provided as banner ads on a web page, as ads presented with search results, or as ads presented in a mobile application.

One can refer to the inclusion of an ad in a medium, e.g., a web page or a mobile application, as an impression. An advertising system can include an ad in a web page, for example, in response to one or more keywords in a user search query input to a search engine. If a user selects the presented ad (e.g., by “clicking” the ad), the user is generally taken to another location associated with the ad, for example, to another, particular web page.

### SUMMARY

In general, this specification relates to content presentation.

In general, one aspect of the subject matter described in this specification can be embodied in methods that include the actions of receiving a privacy request from a mobile device, the privacy request including an encoded device identifier; authenticating the request; decoding the device identifier; retrieving mobile device advertising data associated with the decoded device identifier; and applying the privacy request to the mobile device advertising data. Other embodiments of this aspect include corresponding systems, apparatus, and computer program products.

These and other embodiments can optionally include one or more of the following features. Authenticating the request includes comparing text provided in response to a security image with the text encoded in the security image. The method further includes mapping the received device identifier to a random identifier assigned to the device identifier; and using the random identifier to retrieve the mobile device advertising data.

Retrieving mobile device advertising data includes retrieving values assigned for each ad presented to a mobile application on the device. Retrieving values includes retrieving values associated with conversion tracking for one or more ads. Retrieving values includes retrieving values associated with frequency capping.

The privacy request is a clear history request and where applying the clear history request includes: resetting the random identifier associated with the device identifier including clearing existing mobile device advertising data associated with the random identifier. The privacy request is a tracking opt out request and where applying the tracking opt out request includes clearing mobile device advertising data and inserting a dummy record, wherein the dummy record indicates that ads provided to the mobile device are not tracked. Applying the privacy request to the mobile device advertising data modifies mobile device advertising data for all mobile applications of the mobile device for which data is stored. Applying the privacy request to the mobile device advertising data modifies mobile device advertising data for specified mobile applications of the mobile device for which data is stored.

Particular embodiments of the subject matter described in this specification can be implemented to realize one or more of the following advantages. User information can be stored securely to retain user privacy. Users can control privacy for mobile applications based on a desired privacy level. Additionally, ads that are relevant to particular users can be provided without impairing user privacy.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram of an example advertising system.

FIG. 2 is a block diagram of an example system including a mobile device application.

FIG. 3 is a block diagram of an example advertising system including a mobile device.

FIG. 4 is a flow chart of an example method of retrieving a device identifier and sending a privacy request to an ad system.

FIG. 5 is a flow chart of an example method of receiving a device identifier and a privacy request from a mobile device.

Like reference symbols in the various drawings indicate like elements.

### DETAILED DESCRIPTION

Users can be presented with content items (e.g., ads). Content items can be displayed in various forms on a user device (e.g., a mobile phone, PDA, desktop computer). Different ways in which the user interacts with the content item can be counted as a conversion. For example, the user can click on the content item to reach a particular landing page, the user can buy a product from the landing page, or the user can interact with the content item in other ways. These conversion can be tracked in order to, for example, charge advertisers for the conversion.

In some implementations, content items can be presented within applications executing on a mobile device. For example, a mobile device can include a number of distinct applications, each providing different application content (e.g., a news application, a game application). Content items (e.g., ads) can be presented along with the application content while the application is executing. A privacy management application can be used by a user of the mobile device to control features associated with the presentation of content items within advertisements, including, for example, opting-out of content item tracking associated with the user.

While reference will be made below to advertising systems and methods, other forms of content including other forms of sponsored content can be managed, presented, and tracked in accordance with the description below.

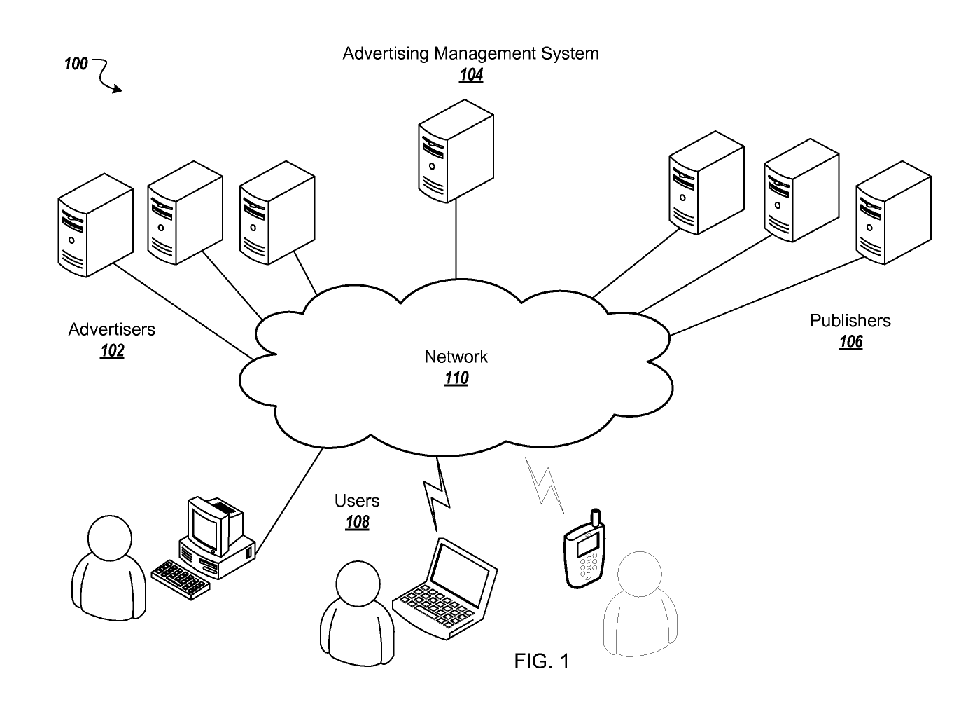

FIG. 1 is a block diagram of an example advertising system 100. In some implementations, one or more advertisers 102 can directly, or indirectly, enter, maintain, and track ad information in an advertising management system 104. Though reference is made to advertising, other forms of content, including other forms of sponsored content, can be delivered by the system 100. The ads can be in the form of graphical ads, such as banner ads, text only ads, image ads, barcode ads (e.g., ads including one or more barcodes for use in redeeming the ads), audio ads, video ads, ads combining one or more of any of such components, etc. The ads can also include embedded information, such as links, meta-information, and/or machine executable instructions.

One or more publishers 106 may submit requests for ads to the advertising management system 104. The advertising management system 104 responds by sending ads to the requesting publisher 106 for placement on or association with one or more of the publisher's content items (e.g., web properties). Example web properties can include web pages, television and radio advertising slots, and even print media space.

Other entities, such as users 108 and the advertisers 102, can provide usage information to the advertising management system 104, such as, for example, whether or not a conversion or click-through related to an ad has occurred. This usage information can include measured or observed user behavior related to ads that have been served. The advertising management system 104 can perform financial transactions, for example, crediting the publishers 106 and charging the advertisers 102 based on the usage information.

A computer network 110, such as a local area network (LAN), wide area network (WAN), the Internet, or a combination thereof, connects the advertisers 102, the advertising management system 104, the publishers 106, and the users 108.

One example publisher 106 is a general content server that receives requests for content (e.g., articles, discussion threads, music, video, graphics, search results, web page listings, information feeds, etc.), and retrieves the requested content in response to the request. The content server can submit a request for ads to an advertisement server in the advertising management system 104. The ad request can include the number of ads desired. The ad request can also include content request information. This information can include the content itself (e.g., page, video broadcast, radio show, or other type of content), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server or a client browser can combine the requested content with one or more of the ads provided by the advertising management system 104. The combined content and ads can be sent to the users 108 that requested the content for presentation in a viewer (e.g., a browser or other content display system). The content server can transmit information about the ads back to the advertisement server, including information describing how, when, and/or where the ads are to be rendered (e.g., in HTML or JavaScript™)

Another example publisher 106 is a search service. A search service can receive queries for search results. In response, the search service can retrieve relevant search results from an index of documents (e.g., from an index of web pages). Search results can include, for example, lists of web page titles, snippets of text extracted from those web pages, and hypertext links to those web pages, and may be grouped into a predetermined number of (e.g., ten) search results.

The search service can submit a request for ads to the advertising management system 104. The request can include a number of ads desired. This number can depend on the search results, the amount of screen or page space occupied by the search results, the amount of screen or page space available for the search results and the ads, the size and shape of the ads, etc. The request for ads can also include the query (as entered or parsed), information based on the query (such as geo-location information, whether the query came from an affiliate and an identifier of such an affiliate), and/or information associated with, or based on, the search results. The information can include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores are computed from, for example, dot products of feature vectors corresponding to a query and a document, page rank scores, and/or combinations of IR scores and page rank scores, etc.

In some implementations, the advertising management system 104 includes an auction process to select ads from the advertisers 102. For example, the advertisers 102 may be permitted to select, or bid, an amount the advertisers 102 are willing to pay for each presentation of or interaction with (e.g., click) of an ad, e.g., a cost-per-click amount an advertiser pays when, for example, a user clicks on an ad. The cost-per-click can include a maximum cost-per-click, e.g., the maximum amount the advertiser is willing to pay for each click of an ad based on a keyword, e.g., a word or words in a query. Other bid types, however, can also be used. Based on these bids, ads can be selected and ranked for presentation.

The search service can combine the search results with one or more of the ads provided by the advertising management system 104. This combined information can then be forwarded to the users 108 that requested the content. The search results can be maintained as distinct from the ads, so as not to confuse the user between paid ads and presumably neutral search results.

In some implementations, one or more of the publishers 106 may submit requests for ads to the advertising management system 104. The advertising management system 104 responds by sending ads to the requesting publisher 106 for placement on one or more of the publisher's web properties (e.g., websites and other network-distributed content) that are relevant to the web property. For example, if one of the publishers 106 publishes a sports-related web site, the advertising management system 104 can provide sports-related ads to the publisher 106. In some other implementations, the requests are executed by devices associated with the user 108, e.g., by the execution of a javascript when the publishers web page is loading on a client device.

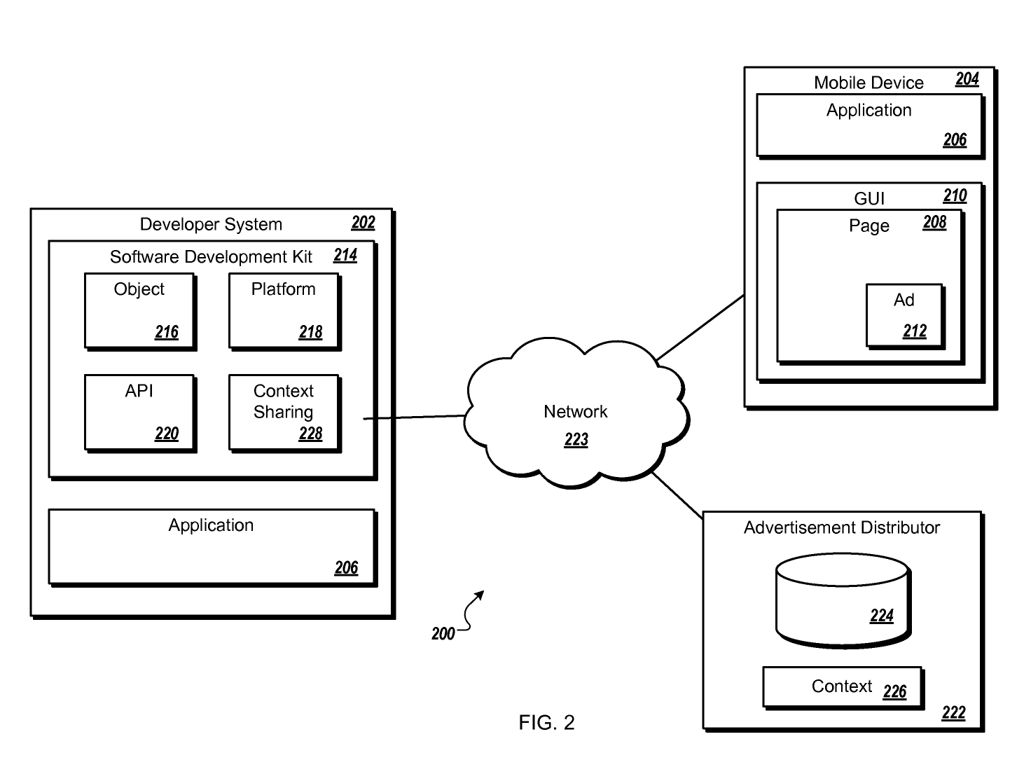

Another example publisher 106 is a mobile application developer. A mobile application is an application specifically designed for operation on a mobile device (e.g., a smartphone). The mobile application can also include one or more ads positioned within the content of the mobile application. Similarly to publishers 106, the ads can be received from the advertising management system 104 for placement in the mobile application when accessed by a user (e.g., when a particular page of a mobile application is loaded on the mobile device). Mobile applications are described in greater detail below with respect to FIG. 2.

FIG. 2 is a block diagram of an example of a system 200 including a mobile device application. In this example, a developer system 202 can be used by a developer to create program content such as applications for one or more mobile devices 204. The mobile devices 204 can include, for example, a cellular telephone, a personal digital assistant or any other type of mobile device. Particularly, the developer can create an application 206 such as by generating program code and compiling it into an executable program compatible with the mobile device 204. The application 206 can be formulated so that it presents one or more pages 208 in a graphical user interface 210 of the mobile device 204, such as on a display screen. Individual systems and/or components can be implemented using hardware, firmware, software, or combinations thereof, and can be divided or joined into different number of units. Examples below will illustrate how the developer can configure the application 206 so that content 212, for example, as an advertisement from a third party, can be presented on the page(s) 208 when the application 206 is being executed.

A software development kit 214 can be provided to the developer for creating the application 206 and/or other programs. The software development kit 214 can provide editors for code and/or pseudocode, one or more compiling functions, emulating functions for previewing display content, and a debugging function, to name just a few examples. In some implementations, the software development kit 214 can also be configured to provide the developer a convenient way of adding third-party content such as advertisements to a program created for mobile devices. For example, the software development kit 214 can provide the developer with the necessary code and/or other application content so that advertisements are requested, displayed to a user, and that any interaction between the user and the ad is tracked.

The software development kit 214 can provide one or more objects 216. In some implementations, the developer can incorporate the object 216 in the code when creating the application. For example, the software development kit 214 can provide the object(s) 216 on a screen, such as where the developer generates the overall application content, in a way that the developer can select the object and include the corresponding material in the application 206 as it is being created.

The software development kit 214 can be configured so that the application(s) 206 can be created according to a particular platform 218. In some implementations, the platform 218 can be targeted to mobile devices, such as to the type of the mobile device 204 which can include a cell phone, a handheld device, or a personal digital assistant, to name just a few examples. For example, the platform 218 can be a platform created or supported by the Open Handset Alliance. In some implementations, the object 216 is included before the application code is compiled into an executable program. For example, the object can be incorporated as an integrated part of the application by inserting code before compilation.

The object 216 can perform one or more functions. In some implementations, the object can cause third party content such as the advertisement(s) 212, to appear on the mobile device 204. For example, the object 216 can be responsible for requesting relevant ad(s), displaying the ad(s) in the right manner to the user, and tracking whether the user clicks on the ad or otherwise interacts with the ad.

In some implementations, the object 216 is a Java object that is configured to be added to a user interface of the application 206 and handle fetching and rendering of, and interaction with, content such as advertisements. For example, the developer can implement a view object that extends a view class associated with the application 206. In some implementations, an advertising view object could include the following: GoogleBaseAdView(String client).

This object can represent a base class to create an advertisement view. A constructor can set the client parameter in a content ads request that can include a URL for a frontend involved in content requests. The above object can extend a more general view class, such as a WebView class used in some implementations from Google Inc. and can in some implementations be extended by other more specific classes directed at advertising. In some examples, such an extension can use void setAdLayoutType(int placement) to specify top and/or bottom placement of the view that requests the content. Other ways of displaying the content (e.g., an ad) can be used, such as a gallery that places thumbnails of image content in a gallery view.

One or more functions can be used with the object. Such function(s) can customize the look and feel of the content when it is displayed. In some implementations, such function(s) can set one or more CGI parameters in a content request.

An application program interface (API) 220 can be used with the object 216. In some implementations, the API is a Java API that a developer can call when incorporating content such as advertisements into the application 206. For example, the object 216 can include a Java code snippet that uses the Java API 220 so that the developer can insert the code into the application 206. As noted earlier, such a code snippet can construct a request for content such as an ad based on a developer's customization, fetch the content and write it to the user interface of the application 206.

The ad 212 can include a number of different types of content. In some implementations, ad types including, but not limited to, text ads, image ads (including static and animated images) and video ads can be used. For example, the ad can provide for user navigation (e.g., a link) to other content associated with the advertiser. Other types of content are possible (e.g., non-advertising content).

An advertisement distributor system 222 can be used to forward any type of content such as the ad 212 to the mobile device 204 and/or the developer system 202. In some implementations, the advertisement distributor system 222 is configured to receive request(s) for content from the mobile device 204, fetch one or more matching ads or other content from a repository 224, and forward the matching content to the mobile device 204. For example, the matching of the ad 212 can be performed using a context component 226 that can provide one or more context parameters associated with the application 206 configured for identifying matching content/advertisements.

The developer system 202, the mobile device 204 and/or the advertisement distributor system 222 can be connected using any kind of network 223, such as the Internet. For example, the developer system 202 and the advertisement distributor system 222 can communicate using the TCP/IP suite of protocols and the mobile device 204 can communicate using any kind of wireless protocol, such as IEEE 802.11, WAP and/or Bluetooth.

Relevant context of the application 206 and/or the mobile device 204 can be shared in different ways. In some implementations, the developer can share context including metadata about the application 206 with the advertisement distributor system 222. A context sharing component 228 in the software development kit 214 can allow the developer to enter one or more keywords that the developer decides are relevant for retrieving and presenting content such as advertisements. For example, the developer who creates the application can submit the keyword(s) using the context sharing component 228 for receipt by the context component 226 for storage. In some implementations, monitoring can be performed to determine how well the submitted metadata correlates with the application 206 and if necessary, modifications in the used context parameter(s) can be made.

In some implementations, context can be shared by the developer submitting the application 206 to the advertisement distributor system 222. The context sharing component 228 can be used in submitting some or all of the application 206 for use in evaluating context. This can be done as part of a setup process so that the advertisement distributor system 222 can examine the application to determine the context of the content/ads to be forwarded. Examples of aspects that can be taken into account include, but are not limited to, textual content of a previous screen or page on the mobile device 204, a content of the entire application 206, and/or content of other view objects such as sibling objects.

Analysis of the application 206 can include analyzing the code (such as by static analysis), determining a general context of the application 206, or determining the specific context of one or more of the particular pages 208. This can require the context component 226 to determine which of the pages 208 is currently active in the mobile device 204. For example, this can be done using a version of the application 206 provided by the developer. If or when the application 206 is later updated, a revised version can be forwarded to the advertisement distributor system 222, for example using the context sharing component 228, so that the context can be updated if necessary.

As another example, context can be determined by providing that the developer can specify one or more hooks in the code of the application 206. In some implementations, the software development kit 214 and/or the platform 218 can provide such feature(s). For example, a global variable can be made to change state at one or more stages of the application 206. Such a variable can be read by the object 216, such as by a snippet of Java code.

Context parameter(s) for use in finding matching content such as ads can be stored in any of a variety of forms. For example, the context component 226 can store one or more keywords, categories, labels, topics, context information and/or any other kind of parameter for use by the advertisement distributor system 222.

The following is an example of how an implementation as described above can be used. A developer can create the application 206 intended for the mobile device 204 using the software development kit 214. Particularly, the application 206 can be created according to the platform 218 and can include the object 216. The developer can forward the application 206 to the mobile device for use, for example when the device 204 is initially sold or as a later update, such as by a download process. The developer can also provide context relating to the application 206, such as by submitting one or more keywords and/or providing a version of the application 206, using the context sharing component 228. One or more context parameters can be registered at the advertisement distributor system 222.

When a user operates the mobile device 204, content such as one or more ads 212 can be presented on the page(s) 208. The content can be selected for presentation by the advertisement distributor system 222 based on the context parameter(s). In some implementations, the user can interact with the ad(s) 212 in one or more ways, such as by clicking on the ad 212, performing a developer-specified combination of key presses (e.g., tapping a single key twice, or tapping two keys in rapid succession), or tapping on the ad on a touchscreen device.

Content such as ads can be retrieved in any of a variety of ways. In some implementations, content can be retrieved essentially according to an on-demand approach. For example, ads or other content can be requested from the advertisement distributor system 222 and forwarded from there for display. Such implementations can have the advantage that the ad that is displayed to the user can be very current to the particular state of the application 206 and/or the mobile device 204.

In some implementations, a pre-fetch approach can be used. For example, a developer can configure the application 206 such that multiple content portions such as ads are requested from the advertisement distributor system 222. The ads can be stored at a suitable location, such as on the mobile device 204 and/or on another computer device such as a server that communicates with the mobile device 204. At some point, such as by determination performed by the application 206, the ad(s) can be displayed on the mobile device 204, for example when it returns to an online mode after having been offline. The developer can provide for reporting of which contents/ads have been displayed, for example by incorporating a feature from the software development kit 214 into the application 206. In some implementations, client-side frequency capping can be used, for example by having a class associated with content/ad presentation track previously served content/ads and ensure that the same content/ad is presented according to a rule (e.g., not more than a predetermined number of times per session). Other approaches for fetching content can be used.

In some implementations, a new content portion such as the ad 212 can be presented when an activity that uses the class associated with content/ad presentation is displayed for the first time. As another example, the new ad/content can be presented when the activity has been removed from an activity stack in the mobile device 204. In yet another example, a content/ad can be presented if a previous ad/content has been displayed for a predetermined amount of time if the mobile device 204 continues to be active (e.g., if a backlight of the display on the device remains on). In some implementations, the developer can facilitate user-initiated refresh of content/ads via a class responsible for generating gallery views, for example to provide a carousel-style browsing of ads.

The software development kit 214 has been mentioned in examples above. In some implementations, the kit 214 can be extended or enhanced using a wizard in an interface directed toward publishers. For example, the advertisement distributor system 222 can provide a user interface where publishers can establish an account to become affiliated with an advertising program, and this interface can feature the wizard as a way for the developer(s) to customize the look and feel of content/ads to be displayed in connection with the application 206. In some implementations, this can be implemented as a self-service sign-up process for developers, for example to allow the opportunity to enhance their application offering with ads and/or other content. As another example, and assuming that users' privacy rights are taken into account, such an interface can provide reporting statistics on ad clicks, impressions, queries, revenue and/or other aspects to the advertisement distributor system 222.

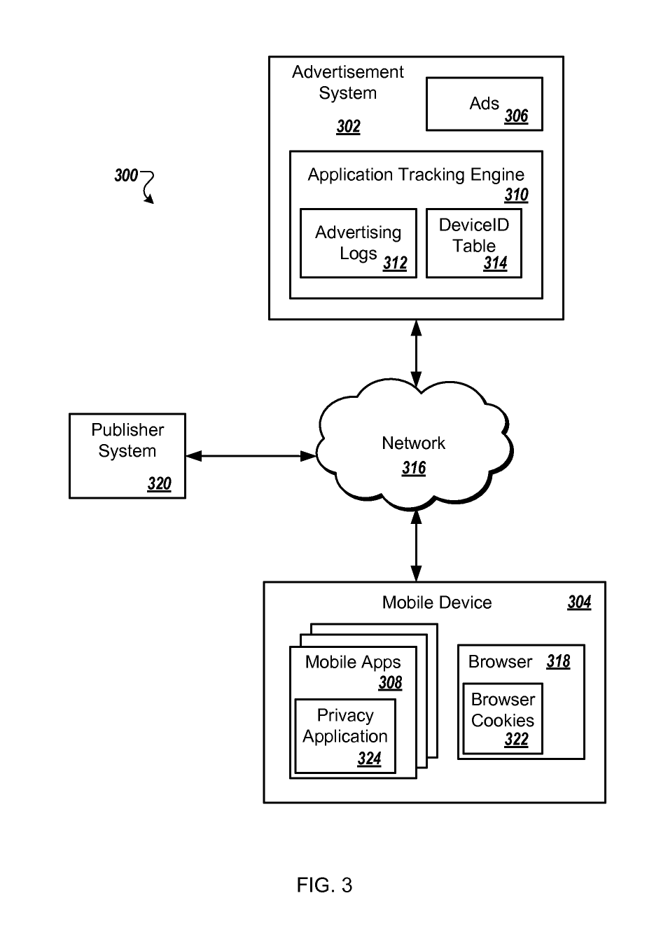

FIG. 3 is a block diagram of an example advertising system 300 including a mobile device. The advertising system 300 can be used to serve ads and other content to a mobile device. A privacy application on the mobile device can send a privacy request to the advertisement system so that information related to the mobile device is removed from the advertisement system as well as to request that future ads not be tracked, as described in greater detail below.

The system 300 includes an advertisement system 302. In some implementations, a mobile device 304 requests content from the advertisement system 302, e.g., one or more advertisements 306, web pages, video or audio streams, images, or other media, to name a few examples. The advertisement system 302 can serve content, including the ads 306, to the mobile device 304 for presentation on a user interface of the mobile device 304.

In some implementations, one or more mobile applications 308 running on the mobile device 304 requests ads from the advertisement system 302. The mobile applications 308 can be created for the mobile device 304, for example, using the developer system 202 of FIG. 2. The types of mobile applications 308 can include games, utilities, news applications, and configuration tools, to name a few examples. The mobile applications 308 can be installed on the mobile device 304 before the device is initially sold by a manufacturer, or the mobile applications 308 can be installed onto the mobile device at a later time (e.g., through a download process from a mobile device application store). The mobile applications 308 can obtain an identifier for the device, e.g., a device identifier of the mobile device 304 through an API of the mobile application. The device identifier can be, for example, a deviceID for the device or other hardware identifier for the mobile device. The device identifier can be, for example, a unique alphanumeric identifier associated with the mobile device

The advertisement system 302 can include an application tracking engine 310 for tracking user interaction with the ads 306 presented in one or more of the mobile applications 308. The application tracking engine 310 can store data with tracking information in one or more advertising logs 312. The advertising logs 312 can include a table for storing rows of data associating a mobile device with advertising events. In some implementations, the advertising logs 312 include a device identifier field for storing the device identifier of the mobile devices when associating the mobile devices with advertising events. The device identifier can be unique for each mobile device in the system 300. In some implementations, the advertising logs 312 can include an application ID field for tracking the mobile application that triggered the advertising event. The advertising logs 312 can also include ad identifiers (e.g., identifiers for ad cookies (“adCookieIDs”)), conversion tracking identifiers, and/or advertisement frequency capping information.

In other implementations, the application tracking engine 310 generates a random identifier (“randomID”) for each device identifier in order to preserve user privacy by not logging mobile device identifiers in the advertising logs 312. The application tracking engine 310 can store the mapping relating a random identifier to a device identifier in a device identifier table 314. In this example, the advertising logs 312 include a random identifier field for storing the random identifier associated with a mobile device instead of the device identifier. The random identifier value is used in the advertising logs 312 to associate a mobile device with advertising events. In some implementations, the device identifier table 314 is stored in another location, e.g., a different server, in order to securely store user device identifiers.

The application tracking engine 310 can receive a device identifier for the mobile device 304. For example, when a user selects an ad, the device identifier can be sent to the ad system 304 along with other data associate with an advertising event. Advertising events can include presentation of an ad in one of the mobile applications 308, or user selection of one of the ads 306 to name a few examples. The application tracking engine 310 can query the device identifier table 314 for the random identifier mapped to the device identifier and create an entry in the advertising logs 312 associating the detected advertising event with the random identifier.

If the device identifier table 314 does not include a row associated with the device identifier of the mobile device 304, the application tracking engine 310 can generate a new record in the device identifier table 314 mapping a generated random identifier to the device identifier, where the random identifier will be associated with the device identifier for subsequently received ad information from the mobile device.

Each row of the device identifier table 314 can be for a unique device identifier associated with a single mobile device. The device identifier table 314 can include a conversion tracking information field for each row. Conversions can describe different responses to the ad by the user (e.g., clicking on the ad, interacting with the ad, performing an action on an advertiser web page associated with the ad). For example, the conversion tracking information field can store data used to determine if a user makes an advertiser specified action after clicking on an ad. An advertiser can define a conversion as filling out a form, making a purchase, or signing up for a mailing list, to name a few examples.

The device identifier table 314 can also include a frequency capping field for each row. The frequency capping field can be used to limit the number of times an ad is presented on the mobile device 304 within a specified period of time. For example, the advertisement system 302 can use frequency capping to prevent a user from being exposed to one of the ads 306 more than an advertiser specified number of instances. The device identifier table 314 can include privacy settings for each row to allow a user of the mobile device 304 to specify what information the application tracking engine 310 tracks. In some implementations, the device identifier table 314 can track the applications that trigger advertising events with an application ID field or some other mobile application identifier.

In some implementations, the device identifier table 314 includes additional data.

For example, for each row associated with a particular device identifier, conversion data location history data, and application data (e.g., names of applications on the user device retrieved from application ad requests) can be included.

The mobile device 304 can be a cellular telephone, a smartphone, a personal digital assistant, or any other type of mobile device. In this example, the mobile device 304 can be used to make telephone calls, voice over internet protocol (VoIP) calls, and to browse the World Wide Web or any other type of network. The mobile device can receive user input from a touch screen interface, a keyboard, a trackball, or a stylus, to name a few examples. The mobile device 304 can connect to the advertisement system 302 through a network 316, such as the Internet. In other implementations, the network 316 is a LAN, a WAN, or any combination thereof. The mobile device 304 can communicate using any kind of wireless protocol, such as IEEE 802.11, WAP and/or Bluetooth.

The mobile device 304 can include a browser 318 for browsing the Internet, e.g., the World Wide Web, or for accessing other content on a network (e.g., documents, images, and other forms of media). The browser 318 can request content from a publisher system 320, such as a search engine, for display on a user interface of the mobile device 304. In some implementations, the publisher system 320 sends one or more browser cookies 322 to the browser 318 in addition to the requested content. For example, the browser cookies 322 can be used to track the number of times content, such as a web page, is displayed on the user interface of the mobile device 304. The browser cookies 322 can optionally be used for tracking ads, such as the ads 306, presented in the browser 318. In some implementations, the browser cookies 322 can track a user session on a web site.

The publisher system 320 can request ads from the advertisement system 302, such as one of the ads 306. The publisher system 320 can send the ads 306 to the browser 318 such that the ads 306 are displayed on the browser 318 along with the requested content. The publisher system 320 can connect to the network 316 and communicate with the advertisement system 302 and the mobile device 304 through the network 316.

In some implementations, the browser 318 can request a web page using a browser that includes one or more ads. Consequently, ads are requested from the advertisement system 302 for incorporation into the web page content. The advertisement system 302 can send one or more of the ads 306 to the browser 318. The browser 318 can combine the requested content with the ads 306 for presentation on a user interface of the mobile device 304. The advertisement system 302 can send one or more cookies to the mobile device 304 for storing information related to the requested web page and the ads 306. The mobile device 304 can store the cookies with the browser cookies 322. The cookies can be used to track which of the ads 306 were presented on the mobile device 304, or a user session on a web site.

In another example, one of the mobile applications 308 can present the ads 306 on the mobile device 304. For example, the mobile applications 308 can include a poker game that presents ads while a user of the mobile device 304 plays the poker game. If the user interacts with one of the ads 306, the poker game can generate a request URL for a web page associated with the selected ad and send the URL request to the advertisement system 302. The URL request can include the device identifier of the mobile device 304.

Continuing the example, the advertisement system 302 can receive the URL request and generate a browser cookie associated with the selected ad. The generated cookie can have an AdCookieID. Conversion data can be stored by the application tracking engine 310 in the device identifier table 314. For example, an application ID for the poker game, the device identifier, and a conversion ID for a conversion cookie can be stored in the device identifier table 314. The application tracking engine 310 can use the device identifier from the URL request to determine the associated random identifier stored in the device identifier table 314. The application tracking engine 310 can use the random identifier and the AdCookieID to create a record (e.g., a row) in the advertising logs 312. The advertisement system 302 can send the generated browser cookie to the browser 318 and redirect the browser 318 to the web page associated with the selected ad. The browser 318 can display the web page associated with the ad on the user interface of the mobile device 304.

The mobile device 304 can include a privacy application 324 as one of the mobile applications 308. The privacy application 324 can manage user information stored on a server, such as the advertisement system 302. In some implementations, the privacy application 324 can be installed on the mobile device 304 by a user. In other implementations, the privacy application 324 can be installed on the mobile device 304 before the mobile device 304 is initially sold. When launched, the privacy application 324 can allow users to perform privacy management functions for the mobile device 304. For example, the privacy application 324 can allow the user to control one or more advertising opt-out options associated with one or more mobile applications.

In certain implementations, the privacy application 324 can provide application privacy management for each of the mobile applications 308 separately. In other implementations, the privacy application 324 provides the same privacy settings for all of the mobile applications 308.

In some implementations, the privacy application 324 can independently control conversion tracking and frequency capping information. For example, the privacy application 324 can receive a request to clear the conversion tracking data associated with the mobile device 304 but not to clear the frequency capping data. Similarly, the privacy application 324 can receive a request to clear the frequency capping data associated with the mobile device 304 but not to clear the conversion tracking data.

In some implementations, the privacy application 324 can receive input from a user indicating the length of time conversion data, frequency capping data, and/or adCookie data is stored before the data is cleared from the advertisement system 302.

After the specified length of time has passed, the application tracking engine 310 clears the conversion data and frequency capping data e.g., from the device identifier table 314, for any records associated with the mobile device 304, and generates a new random identifier to device identifier mapping for the mobile device 304. In some implementations, additional data can be managed using the privacy application 324 including location history data, conversion data, and application data stored, for example, in the device identifier table. For example, these fields can be cleared together or individually. Alternatively, an opt out can be applied for one or more of these fields.

In one example, a user can launch the privacy application 324 in order to update privacy settings for the mobile device 304. The privacy application 324 can retrieve the device identifier of the mobile device 304 through a native application API. The privacy application 324 can send the device identifier to the advertisement system 302 and request access to privacy settings stored on the advertisement system 302 that are associated with the device identifier. The application tracking engine 310 can query the device identifier table 314 for privacy settings associated with the device identifier and send the privacy settings to the privacy application 324. The privacy application 324 can provide a user interface that presents the privacy settings to the user, allowing the user to view the settings on a user interface of the mobile device 304. The privacy application 324 can receive input from the user indicating updated privacy settings and send a request to the advertisement system 302 indicating the updated settings.

For example, a user can select a control displayed on the user interface indicating that the ad history of the mobile device 304 should be cleared. The privacy application 324 can send a clear history request to the advertisement system 302 based on the user selection. When the application tracking engine 310 receives a clear history request and a device identifier from the privacy application 324, the application tracking engine 310 can reset the random identifier associated with the device identifier in the device identifier table 314 and clear all existing data associated with the device identifier. In particular, the application tracking engine 310 can map a new random identifier to the device identifier in the device identifier table 314.

The application tracking engine 310 can remove mobile device advertising data stored in the same row as the device identifier and random identifier. For example, the application tracking engine 310 can clear any conversion tracking information and frequency capping information in the row. In some implementations, the privacy application 324 can also interact with the browser to delete browser cookies 322 stored in the browser 318 when the user indicates that the ad history of the mobile device 304 should be cleared.

In another example, a user can indicate that the advertisement system 302 should no longer track the advertising events in mobile applications of the mobile device 304. The privacy application 324 can send an opt out request to the advertisement system 302 based on the user indication. The application tracking engine 310 can receive the device identifier of the mobile device 304 and query the device identifier table 314 for a record associated with the mobile device 304. The application tracking engine 310 can update the record associated with the mobile device 304 with a “dummy record.” The dummy record can include a dummy value for the random identifier (e.g., zero) and no values for the conversion tracking information and frequency capping fields. If the application tracking engine 310 detects advertising events associated with a device identifier and the device identifier table contains a dummy record for that device identifier, the application tracking engine 310 does not track the events.

In particular, since a new entry would be created if there was no device identifier/random identifier mapping, the dummy record indicates that while the device identifier is in the table, no tracking should be performed for ad events occurring on mobile applications of the mobile device 304.

The following is an example of the advertisement system 302 detecting an advertising event after receiving an opt out privacy request from the privacy application 324. For example, the mobile applications 308 can include a social networking application on the mobile device 304. The social networking application can receive input indicating user selection of one of the ads 306 presented in the social networking application. The social networking application can determine that the browser 318 should be launched and the browser 318 can request a URL landing page associated with the selected ad.

Continuing the example, the browser 318 can send the URL request with the device identifier of the mobile device 304 to the advertisement system 302. The device identifier is forwarded from the advertisement system 302 to the application tracking engine 310. The application tracking engine 310 queries the device identifier table 314 and receives a dummy record associated with the device identifier. The application tracking engine 310 determines that advertising events, such as a user selection of an ad, associated with the device identifier should not be tracked based on the privacy settings stored in the device identifier table 314. The advertisement system 302 can redirect the browser 318 to the landing page associated with the selected ad without storing a cookie in the browser 318 or tracking the advertising event in the advertising logs 312 or the device identifier table 314.

In some implementations, the social networking application, or one of the mobile applications 308, can present a prompt to a user after receiving input indicating user interaction with one of the ads 306. For example, the prompt can ask the user if they would like a landing page associated with the ad opened in the browser 318 or the social networking application.

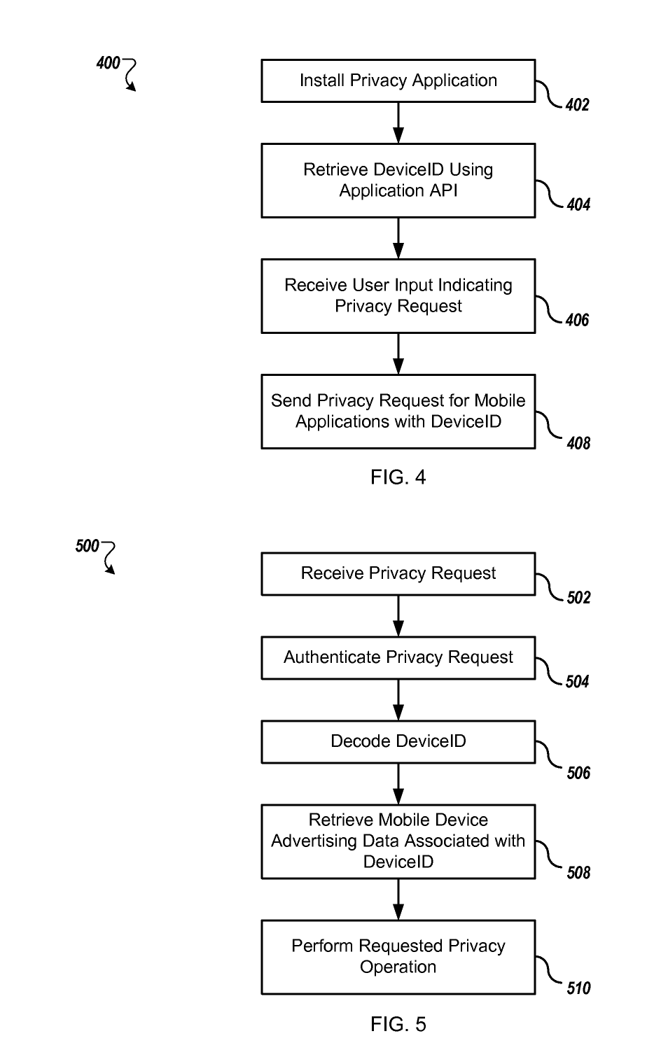

FIG. 4 is a flow chart of an example method 400 of retrieving a device identifier and sending a privacy request to an ad system. A mobile device (e.g., the mobile device 304) and parts thereof will be referred to in the following as examples. The method 400 can be performed by one or more other systems in conjunction with or instead of the mobile device.

A privacy application (e.g., the privacy application 324) is installed (402). For example, the privacy application can be installed on the mobile device. The privacy application can be installed on the mobile device by a user. For example, a user can access a mobile application store in order to download and install the privacy application on the mobile device. In other implementations, the privacy application can be installed before the mobile device is sold. The privacy application can be installed as part of the operating system of the mobile device, or as an additional application, to name a few examples.

The privacy application retrieves a device identifier using an application API (404). For example, the privacy application, when executed, can retrieve the device identifier of the mobile device through a native application API. In some implementations, the privacy application uses a Java API to retrieve the device identifier from the mobile device.

The privacy application receives user input indicating a privacy request (406). For example, the privacy application can receive input from a user indicating a clear history request. The clear history request can be for a specific mobile application on the mobile device (e.g., of mobile applications 308), a group of the mobile applications 308, or for all of the mobile applications. For example, the clear history request can be for a system to remove all history data stored on the system associated with the applications specified by the user. Alternatively, the privacy application can receive an opt out request indicating that a system should no longer track history information for any of the mobile applications. In some implementations, the clear history request or the opt out request includes browser ad tracking associated with the mobile device.

The privacy application sends the privacy request for mobile applications associated with the device identifier (408). For example, the privacy application can send a privacy request to an advertisement system (e.g., the advertisement system 302). The privacy request can be for one or more of the mobile applications as specified by user input received by the privacy application. In some implementations, the device identifier and/or the privacy request can be encoded in order to ensure user privacy. For example, the privacy application can generate a signature with an encryption scheme using the privacy application user-agent string, a time stamp, and the device identifier. The encryption scheme can be a data encryption standard (DES) algorithm, or an advanced encryption standard (AES) algorithm, such as AES-128 or triple-DES. For example, a public key can be used for encryption at the mobile device and a private key for decryption by the advertising system. In some implementations, adding the user-agent string and a time stamp to the signature can make encoding of the device identifier more complex and secure.

In certain implementations, the privacy application can present an authentication challenge to the user before sending the privacy request. For example, when the privacy application receives user indication of a privacy request, the privacy application can request an authentication challenge from the advertisement system. The advertisement system can, for example, send a Captcha test to the privacy application in response to the authentication challenge request. The privacy application can present the Captcha test to the user and receive input from the user indicating the user's response. The privacy application can send the user's response to the advertisement system so that the advertisement system can verify the accuracy of the user's response.

If the user's response is correct, the advertisement system can authenticate the user and accept a privacy request from the privacy application. If the user's response is incorrect, the advertisement system can send another authentication challenge to the privacy application. In other implementations, an authentication challenge is presented to a user after the privacy application sends the privacy request to the advertisement system.

FIG. 5 is a flow chart of an example method 500 of receiving a device identifier and a privacy request from a mobile device. An ad system (e.g., the advertisement system 302) and parts thereof will be referred to in the following as examples. The method 500 can be performed by one or more other systems in conjunction with or instead of the ad system.

A privacy request is received (502). For example, a privacy request can be received by the advertisement system from the mobile device. A privacy application (e.g., the privacy application 324) can, for example, create and send the privacy request to the advertisement system. The privacy application, or another mobile application (e.g., one of the mobile applications 308), can present a user of the mobile device with an authentication challenge in order to verify the user (e.g., that the user is not a machine). For example, the privacy application can present a Captcha challenge word to the user. The privacy request can include the device identifier of the mobile device and an authentication answer. In some implementations, the advertisement system can receive a privacy request from the mobile device and send an authentication challenge to the mobile device in response to the privacy request.

In some implementations, the privacy request indicates an associated application that the privacy request corresponds with. For example, the privacy application can receive input from a user indicating that the history of a specific mobile application or all gaming applications on the mobile device should be cleared. In this example, the privacy request includes information indicating the specific applications for which tracking of advertising events should be removed from one or more advertising logs (e.g., the advertising logs 312) and a device identifier table (e.g., the device identifier table 314). In another example, the privacy application can send an opt out request and include application information indicating specific applications that the advertisement system should no longer track. In certain implementations, the privacy request is for all applications on the mobile device.

The privacy request is authenticated (504). For example, the advertisement system can compare the authentication answer to the Captcha challenge word presented to the user. In some implementations, if the authentication answer is incorrect, the advertisement system can send another Captcha challenge word to the mobile device for presentation to the user.

The device identifier is decoded from the privacy request (506). For example, the advertisement system can use a DES or AES key to decode the privacy request and determine the device identifier for the mobile device. In other implementations, RSA keys can be used to encrypt and decrypt the device identifier and/or the privacy request. In some implementations, a user-agent string and a time stamp are decrypted along with the device identifier.

Mobile device advertising data associated with the device identifier is retrieved (508). For example, an application tracking engine (e.g., the application tracking engine 310) can receive the decrypted device identifier from the advertisement system and determine the row in the device identifier table associated with the decrypted device identifier. The application tracking engine can retrieve the data in the row associated with the decrypted device identifier, including the random identifier mapped to the device identifier, and conversion tracking and frequency capping information for each of the ads (e.g., the ads 306) presented on the mobile device.

If the device identifier table does not include a row associated with the decrypted device identifier, the application tracking engine can create a new record in the device identifier table for the decrypted device identifier. If the privacy request is an opt out request, the application tracking engine can generate a dummy record for the device identifier with blank, null, or zero values in the random identifier, conversion information, and frequency capping information fields. If the privacy request is a clear history request, the application tracking engine can create a new record in the device identifier table and generate a new random identifier mapped to the decrypted device identifier. The application tracking engine can enter blank, null, or zero values for the conversion information field and the frequency capping field in the newly created record.

The requested privacy operation is performed on the mobile device advertising data (510). For example, the application tracking engine can apply the requested privacy policy to the mobile device advertising data stored in the advertising logs and the device identifier table. If the application tracking engine receives a clear history request from the privacy application, the application tracking engine can map a new random identifier to the decrypted device identifier in the device identifier table and clear any conversion tracking and frequency capping information associated with the decrypted device identifier from the device identifier table.

The application tracking engine can, for example, no longer determine that advertising events (e.g., identified in the ad logging) associated with the old random identifier were generated by the mobile device because the device identifier table no longer associates the old random identifier with the device identifier. Advertising events detected by the advertisement system after a clear history request is performed on the mobile device advertising data can be logged in the advertising logs with the new random identifier mapped to the device identifier of the mobile device and in the device identifier table using the device identifier.

If the advertisement system receives an opt out of tracking request, the application tracking engine 310 can remove the data in the row of the device identifier table associated with the decrypted device identifier and insert a dummy record into the row. For example, the application tracking engine can enter a null value, or some other predefined poisonous value, into the random identifier field in the row associated with the decrypted device identifier. When the application tracking engine queries the device identifier table for a device identifier record and receives a row that contains a dummy record or a poisonous random identifier value, the application tracking engine will not track or log any actions associated with the queried device identifier.

For example, the advertisement system receives an opt out privacy request associated with a device identifier from the privacy application. At a later time, the advertisement system can receive a request, including a device identifier, to display the ads in a mobile application on the mobile device. The advertisement system can send the device identifier of the mobile device to the application tracking engine. The application tracking engine can query the device identifier table for a record associated with the device identifier. The application tracking engine can receive a dummy record from the device identifier table in response to the query (e.g., the dummy record is associated with the device identifier sent by the privacy application). The application tracking engine can indicate to the advertisement system that requests associated with the device identifier should not be tracked. The advertisement system serves the ads to the requesting application without sending any cookies to the requesting application, and the application tracking engine does not track the serving of the ads.

In some implementations, the application tracking engine can use application ID information received as part of the privacy request to apply privacy settings for specific applications installed on the mobile device. For example, the device identifier table can map a different random identifier to each device identifier and application ID combination for the mobile applications on the mobile device. The application tracking engine can use the device identifier and application ID to query the device identifier table and perform a clear history privacy request or an opt out of tracking privacy request on an entry in the device identifier table.

In certain implementations, the advertisement system can receive a privacy request that includes privacy settings. For example, privacy settings can include the maximum time tracking information is associated with the device identifier without another advertising event (e.g., presentation of the same ad) triggering logging of the same or similar information. The privacy settings can indicate that the history of one or more of the mobile applications should be automatically cleared on a schedule. In some implementations, tracking or conversion data stored in the advertising logs and/or the device identifier table can expire after a predetermined amount of time (e.g., 30 days).

In some alternative implementations, privacy management can be ad based instead of through a privacy application. For example, an ad can include logic for interacting with the ad to provide control or privacy settings. For example, upon interacting with the add (for example, a type of selection or user input gesture), an option presented can include an edit preferences button. When selected, a request is sent to the ad system as part of a URL prompting a new web view window to be presented allowing the user to interact with the various privacy settings as described above.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. The computer storage medium can be, or be included in, a computer-readable storage device, a computer-readable storage substrate, a random or serial access memory array or device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a privacy request from a mobile device, the privacy request including an encoded device identifier;
authenticating the request;
decoding the device identifier;
retrieving mobile device advertising data associated with the decoded device identifier; and
applying, using one or more processors, the privacy request to the mobile device advertising data.

2. The method of claim 1, where authenticating the request includes comparing text provided in response to a security image with the text encoded in the security image.

3. The method of claim 1, further comprising:
mapping the received device identifier to a random identifier assigned to the device identifier; and
using the random identifier to retrieve the mobile device advertising data.

4. The method of claim 1, where retrieving mobile device advertising data includes retrieving values assigned for each ad presented to a mobile application on the device.

5. The method of claim 1, where retrieving values includes retrieving values associated with conversion tracking for one or more ads.

6. The method of claim 1, where retrieving values includes retrieving values associated with frequency capping.

7. The method of claim 1, where the privacy request is a clear history request and where applying the clear history request includes: resetting the random identifier associated with the device identifier including clearing existing mobile device advertising data associated with the random identifier.

8. The method of claim 1, where the privacy request is a tracking opt out request and where applying the tracking opt out request includes:
clearing mobile device advertising data and inserting a dummy record, wherein the dummy record indicates that ads provided to the mobile device are not tracked.

9. The method of claim 1, where applying the privacy request to the mobile device advertising data modifies mobile device advertising data for all mobile applications of the mobile device for which data is stored.

10. The method of claim 1, where applying the privacy request to the mobile device advertising data modifies mobile device advertising data for specified mobile applications of the mobile device for which data is stored.

11. A system comprising:
a user device; and
one or more computers operable to interact with the device and operable to perform operations comprising:
receiving a privacy request from a mobile device, the privacy request including an encoded device identifier;
authenticating the request;
decoding the device identifier;
retrieving mobile device advertising data associated with the decoded device identifier; and
applying the privacy request to the mobile device advertising data.

12. The system of claim 11, where authenticating the request includes comparing text provided in response to a security image with the text encoded in the security image.

13. The system of claim 11, further operable to perform operations comprising:
mapping the received device identifier to a random identifier assigned to the device identifier; and
using the random identifier to retrieve the mobile device advertising data.

14. The system of claim 11, where retrieving mobile device advertising data includes retrieving values assigned for each ad presented to a mobile application on the device.

15. The system of claim 11, where retrieving values includes retrieving values associated with conversion tracking for one or more ads.

16. The system of claim 11, where retrieving values includes retrieving values associated with frequency capping.

17. The system of claim 11, where the privacy request is a clear history request and where applying the clear history request includes: resetting the random identifier associated with the device identifier including clearing existing mobile device advertising data associated with the random identifier.

18. The system of claim 11, where the privacy request is a tracking opt out request and where applying the tracking opt out request includes:
clearing mobile device advertising data and inserting a dummy record, wherein the dummy record indicates that ads provided to the mobile device are not tracked.

19. The system of claim 11, where applying the privacy request to the mobile device advertising data modifies mobile device advertising data for all mobile applications of the mobile device for which data is stored.

20. The system of claim 11, where applying the privacy request to the mobile device advertising data modifies mobile device advertising data for specified mobile applications of the mobile device for which data is stored.

21. A computer storage medium encoded with a computer program, the program comprising instructions that when executed by data processing apparatus cause the data processing apparatus to perform operations comprising:
receiving a privacy request from a mobile device, the privacy request including an encoded device identifier;
authenticating the request;
decoding the device identifier;
retrieving mobile device advertising data associated with the decoded device identifier; and
applying the privacy request to the mobile device advertising data.

22. The computer storage medium of claim 21, where authenticating the request includes comparing text provided in response to a security image with the text encoded in the security image.

23. The computer storage medium of claim 21, further comprising instructions that when executed by data processing apparatus cause the data processing apparatus to perform operations comprising:
mapping the received device identifier to a random identifier assigned to the device identifier; and
using the random identifier to retrieve the mobile device advertising data.

24. The computer storage medium of claim 21, where retrieving mobile device advertising data includes retrieving values assigned for each ad presented to a mobile application on the device.

25. The computer storage medium of claim 21, where retrieving values includes retrieving values associated with conversion tracking for one or more ads.

26. The computer storage medium of claim 21, where retrieving values includes retrieving values associated with frequency capping.

27. The computer storage medium of claim 21, where the privacy request is a clear history request and where applying the clear history request includes: resetting the random identifier associated with the device identifier including clearing existing mobile device advertising data associated with the random identifier.

28. The computer storage medium of claim 21, where the privacy request is a tracking opt out request and where applying the tracking opt out request includes:
clearing mobile device advertising data and inserting a dummy record, wherein the dummy record indicates that ads provided to the mobile device are not tracked.

29. The computer storage medium of claim 21, where applying the privacy request to the mobile device advertising data modifies mobile device advertising data for all mobile applications of the mobile device for which data is stored.

30. The computer storage medium of claim 21, where applying the privacy request to the mobile device advertising data modifies mobile device advertising data for specified mobile applications of the mobile device for which data is stored.
